(19) United States
(12) Patent Application Publication
(10) Pub. No.: US 2010/0134607 A1
(43) Pub. Date: Jun. 3, 2010

(54) ENDOSCOPIC OBSERVATION APPARATUS AND ENDOSCOPIC OBSERVATION METHOD

(75) Inventor: Yasushige Ishihara, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/531,163

(22) PCT Filed: Mar. 14, 2008
(86) PCT No.: PCT/JP2008/054748

§ 371 Date: Feb. 4, 2010

(30) Foreign Application Priority Data
Mar. 16, 2007 (JP) 2007-069108

(51) Int. Cl. H04N 7/18

(52) U.S. Cl. 348/68; 348/E07.085

(57) ABSTRACT

A quantitative image of a subject is obtained without being influenced by the distance from the subject by accurately measuring the absolute distance between the subject and the tip of a phototransmitter that radiates light onto the subject. There is provided an endoscopic observation apparatus (1) that includes, at the tip of an inserted member (6) to be disposed in a body cavity, a phototransmitter (12) that radiates light onto a subject opposing the tip and a photoreceptor (12) that receives observation light returning from the subject, an ultrasonic sensor (13) that measures the absolute distance between the inserted member (6) and the subject using oscillation of ultrasonic waves, a correcting unit (32) that corrects the luminance information of the observation light on the basis of the absolute-distance information obtained by the ultrasonic sensor (13), and an image generating unit (32) that generates an image of the subject on the basis of the luminance information of the observation light, corrected by the correcting unit (32).

### TECHNICAL FIELD

The present invention relates to an endoscopic observation apparatus and an endoscopic observation method.

### BACKGROUND ART

An example of a known fluorescence endoscope for observing fluorescence generated by irradiating biological tissue with excitation light has a structure shown in Patent Document 1.

This fluorescence endoscope irradiates a living organism with excitation light and detects autofluorescence from the living organism or fluorescence from an agent injected into the living organism as a two-dimensional image, thus allowing diagnosis of a diseased state of the biological tissue, such as degeneration or cancer, from the fluorescence image.

However, to accurately detect the malignancy of cancer cells etc., it is necessary to accurately obtain the absolute value of the amount of fluorescence generated from the biological tissue. The amount of fluorescence received by a photoreceptor disposed at the tip of an inserted portion fluctuates with changes in the distance between the tip of the inserted portion and a subject, such as biological tissue or the like. Thus, it is necessary to obtain the absolute value of the amount of fluorescence irrespective of such fluctuations.

This Patent Document 1 discloses a fluorescence endoscope equipped with a distance measuring device that uses an ultrasonic signal to measure the distance between the tip of the inserted portion and the subject.

Furthermore, an optical imaging apparatus is disclosed which uses a so-called OCT (optical coherence tomography) technology that radiates low-coherence light onto a subject to accurately form a tomogram of the subject from information about the light scattered at the subject (refer to Patent Document 2).

Patent Document 1: Japanese Unexamined Patent Application, Publication No. Hei 10-243920

Patent Document 2: Japanese Unexamined Patent Application, Publication No. Hei 11-148897

### DISCLOSURE OF INVENTION

Patent Document 1 aims to perform fluoroscopy with a fixed gain, when performing fluoroscopy in a wide space, such as the stomach or large intestine, with a technique for controlling the amount of excitation light radiated from an excitation light source in accordance with the distance measured using the ultrasonic signal. Therefore, it decreases the amount of excitation light to observe a close position and increases the amount of excitation light to observe a distant position.

Additionally, the OCT technology in Patent Document 2 is generally used only to form a tomogram of a subject.

The present invention provides an endoscopic observation apparatus and an endoscopic observation method capable of accurately measuring the absolute distance between the subject and the tip of a phototransmitter that radiates light onto a subject to obtain a quantitative image of the subject without being influenced by the distance from the subject.

A first aspect of the present invention is an endoscopic observation apparatus comprising, at the tip of an inserted member to be disposed in a body cavity: a phototransmitter that radiates light onto a subject opposing the tip; a photoreceptor that receives observation light returning from the subject; an ultrasonic sensor that measures the absolute distance between the inserted member and the subject using oscillation of ultrasonic waves; a correcting unit that corrects luminance information of the observation light on the basis of the absolute-distance information obtained by the ultrasonic sensor; and an image generating unit that generates an image of the subject on the basis of the luminance information of the observation light corrected by the correcting unit.

According to the first aspect of the present invention, the absolute distance between the subject and the tip of the inserted member at which the phototransmitter and the photoreceptor are provided is measured by the operation of the ultrasonic sensor. Assuming that illumination light or excitation light from the phototransmitter is uniformly diffused light, the luminance of the observation light from the subject, received by the photoreceptor, is inversely proportional to the square of the absolute distance from its diffusion start position to the subject. Accordingly, by operating the correcting unit using the absolute distance accurately measured by the ultrasonic sensor, the luminance information of the observation light can be accurately corrected.

By generating an image of the subject on the basis of the corrected luminance information by the operation of the image generating unit, an image having an accurate luminance distribution can be obtained irrespective of the distance between the tip of the inserted member and the subject.

In the first aspect of the present invention described above, the phototransmitter may be provided so as to be able to radiate light radially outward of the inserted member over a predetermined region in the circumferential direction (at least part of the circumference); the photoreceptor may be provided so as to be able to receive observation light over the predetermined region in the circumferential direction from the subject; and the ultrasonic sensor may be disposed so as to be able to measure the absolute distances between individual positions in the predetermined region in the circumferential direction and the inserted member.

With this configuration, the light emitted from the phototransmitter is radiated over the predetermined region around the circumference of the subject facing the side of the inserted member. Furthermore, reflected light or observation light, such as fluorescence, over the predetermined region in the circumferential direction, generated from the subject due to irradiation with the light is received by the photoreceptor. Furthermore, the absolute distance between the inserted member and the subject is measured at individual positions over the predetermined region in the circumferential direction (locations in the region irradiated with the light from the phototransmitter) by the ultrasonic sensor. As a result, the luminance information of the observation light from the subject over the predetermined region in the circumferential direction obtained by the photoreceptor is accurately corrected on the basis of the absolute distances in the predetermined region between the inserted member and the individual locations of the subject, and therefore, an image having an accurate luminance distribution can be obtained irrespective of the distance between the inserted member and the subject.

In the first aspect of the present invention described above, a rotational driving unit that rotates at least one of the phototransmitter, the photoreceptor, or the ultrasonic sensor about the axis of the inserted member may be provided.

With this configuration, at least one of the phototransmitter, the photoreceptor, or the ultrasonic sensor fixed to the rotational driving unit is rotated about the axis of the inserted member by the operation of the rotational driving unit. In the case where the phototransmitter is fixed to the rotational driving unit, light can be radiated over a predetermined region in the circumferential direction due to the operation of the rotational driving unit parallel to the radiation of light by the phototransmitter merely by employing a configuration in which the phototransmitter radiates light in one radial direction. In the case where the photoreceptor is fixed to the rotational driving unit, observation light from a predetermined region in the circumferential direction can be received due to the operation of the rotational driving unit merely by employing a configuration in which the photoreceptor receives the observation light from one radial direction. In the case where the ultrasonic sensor is fixed to the rotational driving unit, absolute distances at individual locations in the predetermined region in the circumferential direction can be measured due to the operation of the rotational driving unit merely with a configuration in which the ultrasonic sensor measures the absolute distance between the inserted member and the subject along one radial direction.

In the first aspect of the present invention described above, the ultrasonic sensor may be fixed to the photoreceptor at a predetermined angle in the circumferential direction (in other words, the ultrasonic sensor is fixed such that the emission direction of its ultrasonic waves is shifted in the circumferential direction with respect to the front of the photoreceptor); and the correcting unit may correct the luminance information of the observation light on the basis of absolute-distance information obtained with a shift in time necessary for rotation through the predetermined angle (the difference in orientation between the ultrasonic sensor and the photoreceptor).

With this configuration, the absolute-distance information at the same position as the subject from which observation light to be received by the photoreceptor is generated is obtained as the rotational driving unit rotates the ultrasonic sensor by an amount corresponding to a mounting angle between the photoreceptor and the ultrasonic sensor (an angle formed between the photoreceptor and the ultrasonic sensor). Therefore, the luminance information of the observation light received by the photoreceptor can be accurately corrected on the basis of the absolute-distance information that is obtained with a shift in time by the rotation through the mounting angle of the photoreceptor and the ultrasonic sensor. Thus, the photoreceptor and the ultrasonic sensor can easily be disposed without overlapping them.

In the first aspect of the present invention, a combined-image generating unit may be provided that combines the absolute-distance information obtained by the ultrasonic sensor and the luminance information of the observation light corrected by the correcting unit to generate a combined image in which the luminance information of the observation light is superposed on the outline shape of the subject.

In this way, by displaying the combined image generated by the combined-image generating unit, the outline shape of the subject and the luminance information of the observation light can be observed at the same time, thus allowing the target site, such as a lesion, to be ascertained together with the state of the subject.

A second aspect of the present invention is an endoscopic observation method for imaging by radiating light from the tip of an inserted member disposed in a body cavity onto a subject disposed on the side thereof and receiving observation light returning from the subject, the method including a measuring step of measuring the absolute distance between the inserted member and the subject using oscillation of ultrasonic waves; a correcting step of correcting luminance information of the observation light on the basis of the measured absolute distance; and an image generating step of generating an image of the subject on the basis of the corrected luminance information of the observation light.

According to the second aspect of the present invention, the subject can be observed by inserting the inserted member into the body cavity, radiating light from the tip onto the subject, receiving observation light returning from the subject, and generating an observation image on the basis of the received observation light. In this case, if the distance between the subject and the inserted member changes, the amount of received observation light changes. According to the second aspect of the present invention, in the measuring step, the absolute distance between the inserted member and the subject is measured using oscillation of ultrasonic waves; in the correcting step, the luminance information of the observation light is corrected on the basis of the absolute distance; and in the image generating step, an image of the subject is generated on the basis of the corrected luminance information, and therefore, even if the distance between the inserted member and the subject fluctuates, the state of the subject can be accurately observed without changing the luminance of the observation image.

The present invention offers the advantage of accurately measuring the absolute distance between the subject and the tip of the phototransmitter that radiates light onto a subject to obtain a quantitative image of the subject without being influenced by the distance from the subject.

### BRIEF DESCRIPTION OF DRAWINGS

FIG. 1 is a diagram showing the overall configuration of an endoscopic observation apparatus according to an embodiment of the present invention.

FIG. 2 is a diagram schematically showing the configuration of a probe main body and a probe unit of the endoscopic observation apparatus in FIG. 1.

FIG. 3 is a longitudinal sectional view illustrating the configuration of the tip of the probe main body in FIG. 2.

FIG. 4 is a diagram showing an example of a fluorescence image obtained by the probe main body and the probe unit in FIG. 2.

FIG. 5 is a diagram showing an example of an image showing the absolute-distance information obtained by the probe main body and the probe unit in FIG. 2.

FIG. 6 is a diagram showing an example of a combined image in which the fluorescence image in FIG. 4 and the absolute-distance information in FIG. 5 are combined.

FIG. 7 is a diagram showing an example of a three-dimensional image obtained by combining a plurality of the combined images in FIG. 6 in the longitudinal direction of the probe.

FIG. 8 is a longitudinal sectional view of a first modified example of the probe main body in FIG. 2.

FIG. 9 is a longitudinal sectional view of a second modified example of the probe main body in FIG. 2.

FIG. 10 is a longitudinal sectional view of a modified example of the probe main body in FIG. 9.

FIG. 11 is a diagram schematically showing the configuration of the probe main body and the probe unit in FIG. 9.

FIG. 12 is a diagram showing the overall configuration of a modified example of the endoscopic observation apparatus in FIG. 1.

FIG. 13 is a diagram schematically showing the inserted portion and the scope unit of the endoscopic observation apparatus in FIG. 12.

### EXPLANATION OF REFERENCE SIGNS

A: body-cavity inner wall (subject)
C: axis
D: absolute-distance information
G3: combined image (image)
1: endoscopic observation apparatus
2, 2′: inserted portion (inserted member)
5: video processor (combined-image generating unit)
6: probe main body (inserted member)
12: phototransmitter/receptor (phototransmitter, photoreceptor)
13: ultrasonic sensor
13′,13″: ultrasonic sensor array (ultrasonic sensor)
22: hollow motor (rotational driving unit)
32: distance correcting unit (correcting unit, image generating unit)

### BEST MODE FOR CARRYING OUT THE INVENTION

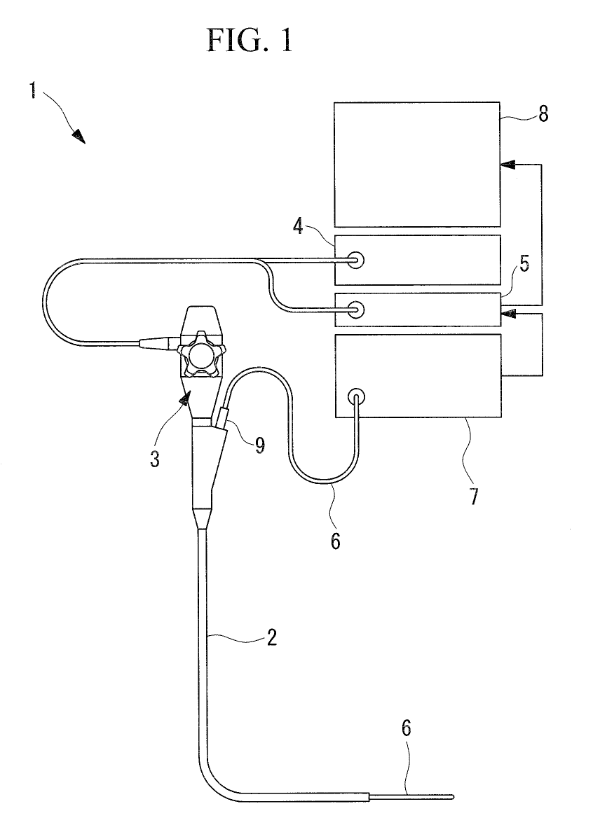

An endoscopic observation apparatus 1 according to a first embodiment of the present invention will be described below with reference to FIGS. 1 to 7.

As shown in FIG. 1, the endoscopic observation apparatus 1 according to this embodiment has a long thin inserted portion 2 to be inserted into a body cavity, an endoscope main body 3 provided with this inserted portion 2, a light source unit 4 and a video processor (combined-image generating unit) 5 for obtaining an endoscopic image of the interior of the body cavity via the endoscope main body 3, a long thin probe main body (inserted member) 6 to be inserted into the tip of the inserted portion 2 through a forceps channel (not shown) provided in the endoscope main body 3, a probe unit 7 connected to the probe main body 6, and a monitor 8 that displays an endoscopic image and a probe image generated by the video processor 5.

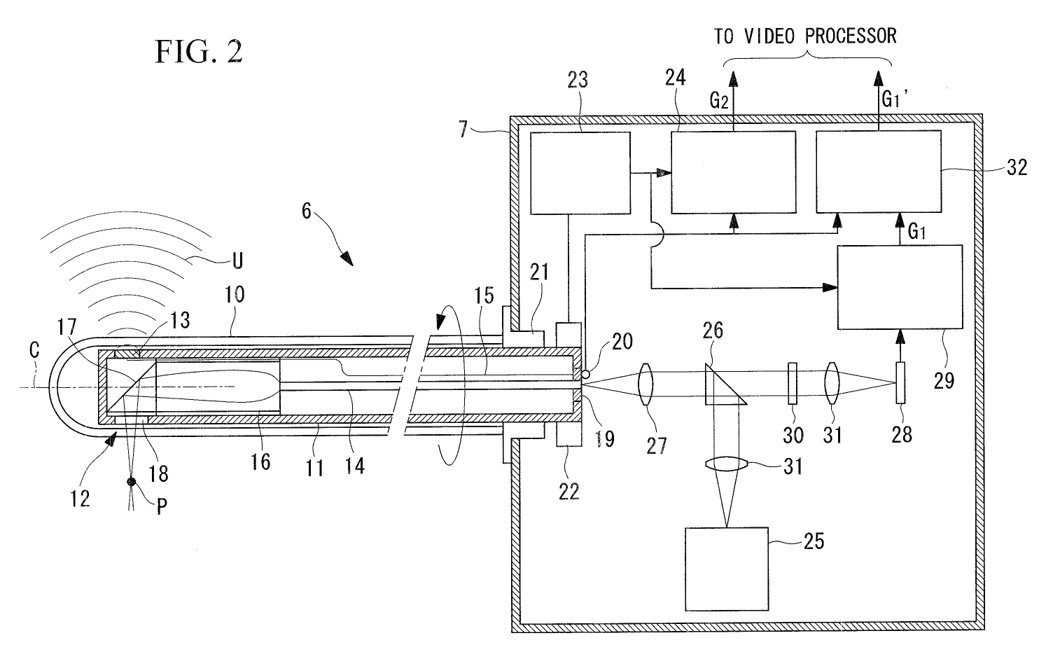

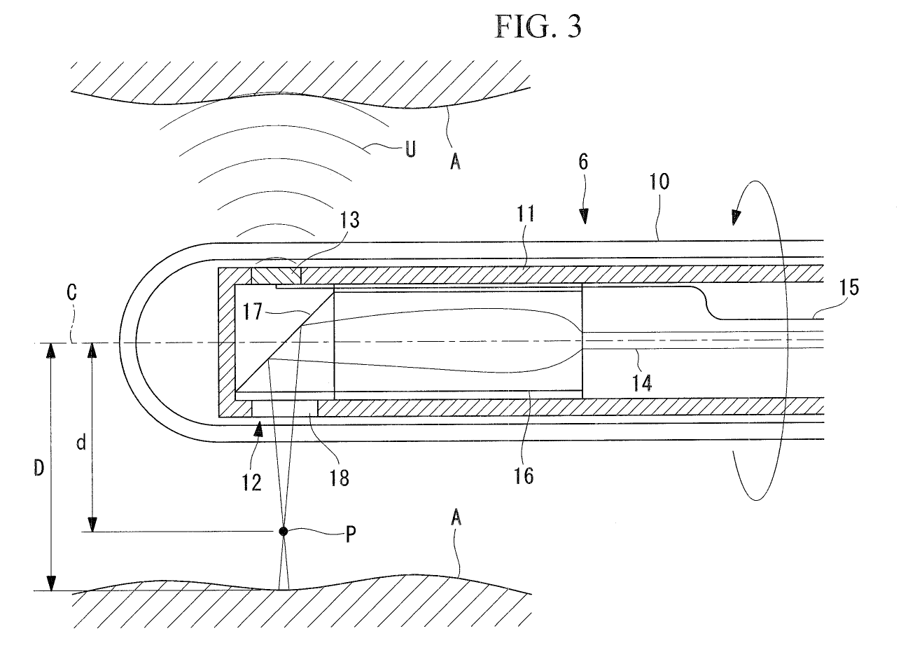

The probe main body 6 is inserted into the forceps channel through a forceps insertion slot 9 provided in the endoscope main body 3 and is configured such that its tip projects from the opening of the forceps channel at the tip of the inserted portion 2. As shown in FIGS. 2 and 3, the probe main body 6 has a transparent tubular sheath 10 that covers the outside thereof in a fluid-tight state, a rotary tube 11 disposed in the sheath 10 substantially coaxially therewith and supported so as to be rotatable about the axis C, a phototransmitter/receptor (phototransmitter and photoreceptor) 12 and an ultrasonic sensor 13 fixed to the tip of the rotary tube 11, and an optical fiber 14 and an ultrasonic-sensor wire 15 that connect the phototransmitter/receptor 12 and the probe unit 7 together.

The ultrasonic sensor 13 is disposed at the tip of the rotary tube 11 so as to be capable of emitting ultrasonic waves U radially outward of the rotary tube 11. The ultrasonic sensor 13 receives an echo signal that returns from a body-cavity inner wall A.

The phototransmitter/receptor 12 is equipped with a GRIN lens 16 connected to the tip of the optical fiber 14, a triangular prism 17 fixed to the tip of the GRIN lens 16, and a window 18 provided at the tip of the rotary tube 11.

Excitation light propagated through the optical fiber 14 propagates through the GRIN lens 16, is thereafter reflected by the reflecting surface at the tip of the triangular prism 17, and is emitted radially outwards of the rotary tube 11 through the window 18. As shown in FIG. 3, the excitation light that is emitted radially outwards of the rotary tube 11 through the window 18 is temporarily focused on a known focal position P (that depends on the focal distance of the GRIN lens 16) and is thereafter diffused and radiated onto the body-cavity inner wall A.

Meanwhile, fluorescence generated from the body-cavity inner wall A enters the rotary tube 11 through the window 18, is reflected by the reflecting surface at the tip of the triangular prism 17, and is introduced into the probe unit 7 through the GRIN lens 16 and the optical fiber 14.

The emission direction of ultrasonic waves U generated by the ultrasonic sensor 13 and the emission direction of excitation light emitted by the phototransmitter/receptor 12 are set to, for example, directions 180° apart in the circumferential direction, that is, in the radially opposite directions. In FIG. 2, reference numeral 19 denotes a contact ring, and reference numeral 20 denotes a contact brush that comes into contact with the contact ring 19 while allowing the relative rotation of the contact ring 19. The contact ring 19 is a terminal connected to the wire provided at the rotary tube 11 side, and the contact brush 20 is a terminal connected to the wire provided at the probe unit 7 side. The use of the contact ring 19 and the contact brush 20 allows transmission of a signal to the rotating rotary tube 11 during rotation, while allowing the rotary tube 11 to rotate with respect to the probe unit 7.

The probe unit 7 is equipped with a connector 21 that rotatably supports the rotary tube 11, an hollow motor 22 that rotates the rotary tube 11, an hollow motor control unit 23 that controls the driving of the hollow motor 22, and an ultrasonic-image generating unit 24 that processes the echo signal detected by the ultrasonic sensor 13 and transmitted through the ultrasonic-sensor wire 15 to generate an ultrasonic image.

The probe unit 7 is further equipped with an excitation-light source 25, a dichroic mirror 26, and a coupling lens 27 for introducing excitation light with a predetermined wavelength range into the near end of the optical fiber 14. The probe unit 7 is further provided with a photodetector 28 that detects fluorescence propagated from the probe main body 6 through the optical fiber 14 and split off from the excitation light by the dichroic mirror 26 and a fluorescence-image generating unit 29 that generates a fluorescence image on the basis of the luminance information of the fluorescence detected by the photodetector 28. In FIG. 2, reference numeral 30 denotes a barrier filter that blocks excitation light traveling from the probe main body 6 toward the photodetector 28 through the dichroic mirror 26, and reference numeral 31 denotes a focusing lens.

The probe unit 7 is further equipped with a distance correcting unit 32 that corrects fluctuations of luminance based on the distances of the pixels of the fluorescence image on the basis of the echo signal detected by the ultrasonic sensor 13. As a correction factor, the distance correcting unit 32 multiplies the luminance information of fluorescence detected by the photodetector 28 by the square of a distance (D−d) obtained by subtracting the distance d from the rotation center to the focal position of the excitation light from the distance D from the rotation center of the rotary tube 11 to the body-cavity inner wall A, which is measured using the echo signal transmitted from the ultrasonic sensor 13.

The distance correcting unit 32 is configured to correct the luminance information of the fluorescence detected by the photodetector 28 using distance information based on the echo signal from the ultrasonic sensor 13 measured at a time shifted from the detection time by the time taken for the rotary tube 11 to rotate by half a revolution.

The ultrasonic-image generating unit 24 is configured to generate an image showing the distance from the rotation center of the rotary tube 11 to the body-cavity inner wall A, around the whole circumference, on the basis of the angular position information of the hollow motor 22, input from the hollow motor control unit 23, and the echo signal detected by the ultrasonic sensor 13, that is, an ultrasonic image showing the outline shape of a cross section of the body-cavity inner wall A, as shown in FIG. 5.

The video processor 5 is equipped with an image combining unit (not shown) that combines the fluorescence-image information corrected by the distance correcting unit 32 in the probe unit 7 and the ultrasonic image generated by the ultrasonic-image generating unit 24. The combined image combined by the image combining unit is output to the monitor 8 and is displayed thereon.

The operation of the thus-configured endoscopic observation apparatus 1 according to this embodiment will be described below.

To perform fluoroscopy of the body-cavity inner wall A using the endoscopic observation apparatus 1 according to this embodiment, the inserted portion 2 provided on the endoscope main body 3 is inserted into the body cavity, and the tip of the inserted portion 2 is disposed in the vicinity of an observation site. In positioning the tip of the inserted portion 2, the light source unit 4 is operated to radiate illumination light from the tip of the inserted portion 2, and a reflected-light image is generated by the video processor 5 on the basis of the obtained reflected light and is displayed as an endoscopic image on the monitor 8. Thus, an operator, such as a doctor, specifies the observation site, such as a diseased part, in the endoscopic image and fixes the tip of the inserted portion 2 at that position.

In this state, the operator manipulates the probe main body 6 to project the tip thereof from the opening at the tip of the forceps channel of the inserted portion 2. Then, the operator activates the probe unit 7 to start the hollow motor 22 to rotate the rotary tube 11 about the axis C in the sheath 10.

The excitation light emitted from the excitation-light source 25 upon activating the excitation-light source 25 is introduced into the optical fiber 14 through the dichroic mirror 26 and the coupling lens 27. The excitation light introduced into the optical fiber 14 is directed radially outward of the rotary tube 11 through the GRIN lens 16 and the triangular prism 17 and is radiated onto the body-cavity inner wall A through the window 18. As a result, fluorescence that is generated due to excitation of a fluorescent material in the body cavity is introduced into the rotary tube 11 through the sheath 10 and the window 18 and is propagated to the interior of the probe unit 7 through the triangular prism 17, the GRIN lens 16, and the optical fiber 14.

At the same time, the ultrasonic sensor 13 and the ultrasonic-image generating unit 24 are activated to radiate the ultrasonic waves U to the body-cavity inner wall A, and an echo signal returning by reflection is obtained, and thus, an ultrasonic image is generated by the ultrasonic-image generating unit 24 on the basis of the echo signal.

The fluorescence propagated to the probe unit 7 is incident on the photodetector 28 through the coupling lens 27, the dichroic mirror 26, the barrier filter 30, and the focusing lens 31, and luminance information at individual positions is obtained.

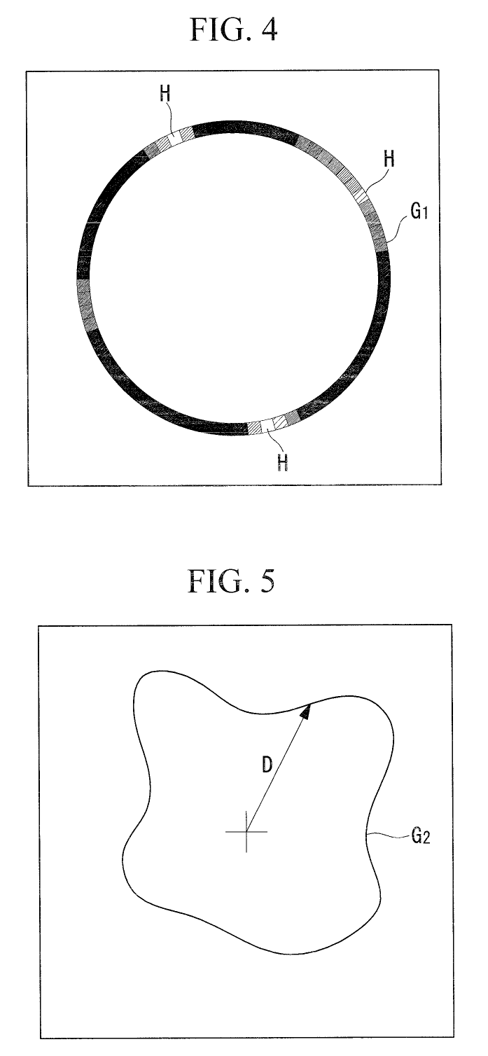

The rotation angle information of the hollow motor 22 and the luminance information of the fluorescence, obtained at the individual positions, are input to the fluorescence-image generating unit 29, and therefore, ring-shaped narrow belt-like fluorescence-image information G1 covering the whole circumference is generated, as shown in FIG. 4.

Meanwhile, the ultrasonic-image generating unit 24 calculates information about the absolute distance between the ultrasonic sensor 13 and the body-cavity inner wall A on the basis of the echo signal obtained by the ultrasonic sensor 13 (measuring step). The ultrasonic sensor 13 is fixed to the rotary tube 11 and is disposed at a certain distance from its axis C. Therefore, absolute-distance information D from the central axis C of the rotary tube 11 to the surface of the body-cavity inner wall A is obtained over the whole circumference on the basis of the echo signal detected by the ultrasonic sensor 13 to generate an absolute-distance image G2.

The ring-shaped long narrow belt-like fluorescence-image information G1 covering the whole circumference, generated by the fluorescence-image generating unit 29, and the absolute-distance information D detected by the ultrasonic sensor 13 are input to the distance correcting unit 32 to generate new fluorescence-image information G1 in which the luminance information at the individual positions in the fluorescence-image information G1 is corrected.

Thus, in the fluorescence-image information G1, a plurality of circumferentially distributed high-luminance regions H accurately shows regions that will generate high-luminance fluorescence when irradiated with excitation light having the same intensity without being influenced by the distance D−d from the light source.

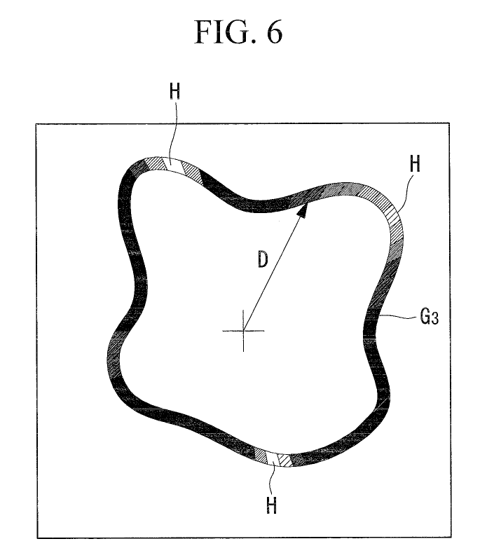

These absolute-distance image G2 and fluorescence-image information G1 in which the luminance is corrected are input to the video processor 5 and are combined to generate a belt-like combined image G3 in which the luminance information is superposed on the individual positions on the outline shape of the cross section of the body-cavity inner wall A, as shown in FIG. 6.

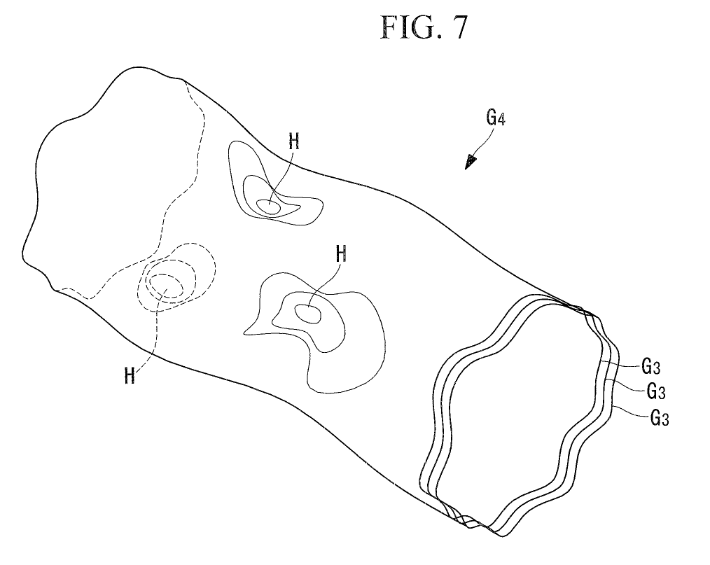

Furthermore, by obtaining a plurality of the above-configured belt-like combined images G3 while slightly moving the probe main body 6 along its axis C, a tubular stereoscopic combined image G4 that extends in the longitudinal direction of the body-cavity inner wall A can be obtained, as shown in FIG. 7. Since this fluorescence image has the exact stereoscopic shape of the body-cavity inner wall based on the absolute-distance information generated by the ultrasonic-image generating unit and the accurate fluorescence luminance information corrected using the absolute-distance information, the lesion has high-luminance regions H, thus allowing accurate diagnosis of the position and state of the lesion.

This embodiment has a phototransmitter/receptor 12 that radiates excitation light and detects fluorescence. However, instead of this, a phototransmitter and a photoreceptor may be provided separately. Furthermore, in this embodiment, the phototransmitter/receptor 12 and the ultrasonic sensor 13 are disposed at positions 180° apart in the circumferential direction of the rotary tube 11. Alternatively, they may be disposed at positions shifted by any angle other than 180° in the circumferential direction of the rotary tube 11.

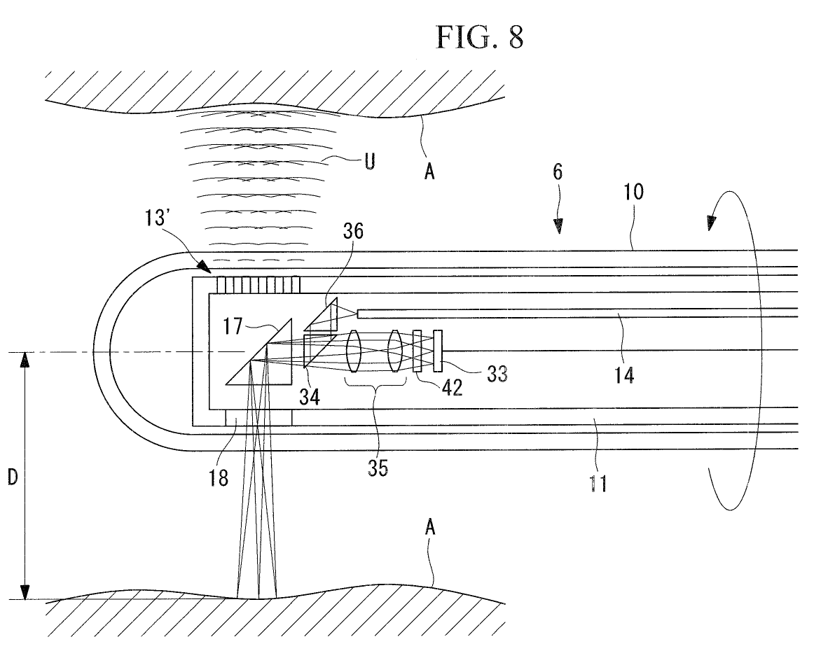

In this embodiment, the fluorescence returning from the minute regions of the body-cavity inner wall A is detected by the photodetector 28, and the rotary tube 11 is rotated to obtain the fluorescence-image information covering the whole circumference, and furthermore, the probe main body 6 is moved in the direction along the axis C to obtain a three-dimensional tubular combined image G4. However, instead of it, the three-dimensional tubular combined image may be obtained by obtaining a linear fluorescence image extending along the axis C using a line CCD 33, as shown in FIG. 8, and by rotating the rotary tube 11 one turn. In this case, an ultrasonic sensor array 13′ in which a plurality of ultrasonic sensors are arranged in the direction along the axis C should be used as the ultrasonic sensor.

In FIG. 8, reference numeral 34 denotes a dichroic mirror, reference numeral 35 denotes an image-capturing optical system, reference numeral 36 denotes a mirror, and reference numeral 42 denotes a barrier filter. With this configuration, the excitation light emitted from the tip of the optical fiber 14 is reflected by the mirror 36 toward the optical axis of the image-capturing optical system 35, is introduced into the triangular prism 17 by the dichroic mirror 34 located on the optical axis of the image-capturing optical system 35, and is reflected by the triangular prism 17 radially outward of the rotary tube 11.

In this case, since the excitation light begins to spread from the time when it is emitted from the end face of the optical fiber 14, the correction factor by which the luminance information is multiplied in the distance correcting unit 32 should be (D+d)2 which involves the distance d (known) from the end face of the optical fiber 14 to the center point of a reflecting surface at the end of the triangular prism 17 and the absolute-distance information D from the central axis C of the rotary tube 11 to the surface of the body-cavity inner wall A.

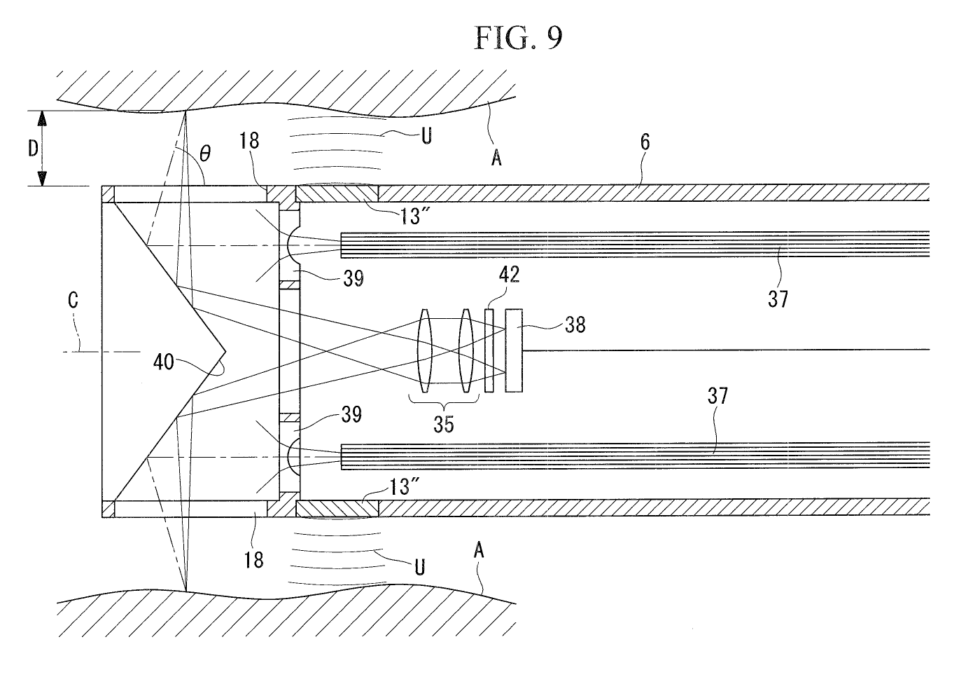

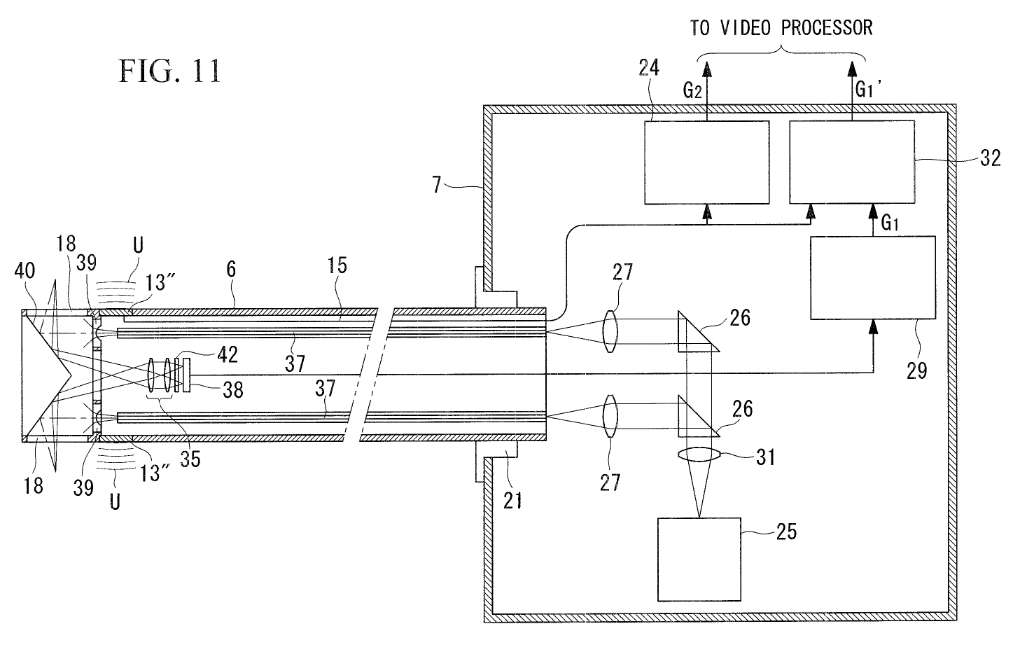

Furthermore, this embodiment obtains the fluorescence image covering the whole circumference by rotating the rotary tube 11 about the axis C. However, instead of this, the fluorescence image covering the whole circumference may be obtained at one time by disposing a conical mirror 40 substantially coaxial with the axis C of the probe main body 6 at the tip of the probe main body 6, as shown in FIGS. 9 to 11. Since this configuration does not have the rotary tube 11, an ultrasonic sensor array 13″ in which a plurality of ultrasonic sensors are arranged in the vicinity of the window 18 should be employed as the ultrasonic sensor. In the drawings, reference numeral 37 denotes a light-guide fiber, and reference numeral 38 denotes a two-dimensional CCD.

With this configuration, the excitation light emitted from the light-guide fibers 37 is radiated radially outward around the whole circumference by the conical mirror 40. Meanwhile, the fluorescence generated from the body-cavity inner wall A is incident on the conical mirror 40 from radially outward around the whole circumference at the same time and is reflected by the conical mirror 40 toward the two-dimensional CCD.

The correction factor by which the luminance information is multiplied in this case should be the square of the distance from a concave lens 39 that spreads out the excitation light to the body-cavity inner wall A. Specifically, the correction factor should be ((D/sin θ)+d)2, which involves the distance d (known) from the concave lens 39 to the outer surface of the probe main body 6 along the optical axis of the excitation light emitted from the light-guide fibers 37, the distance D from the outer surface of the probe main body 6 to the body-cavity inner wall A, detected by the ultrasonic sensor array 13″, and an angle θ formed by the optical axis of the excitation light after reflection by the conical mirror 40 and the axis C direction of the probe main body 6.

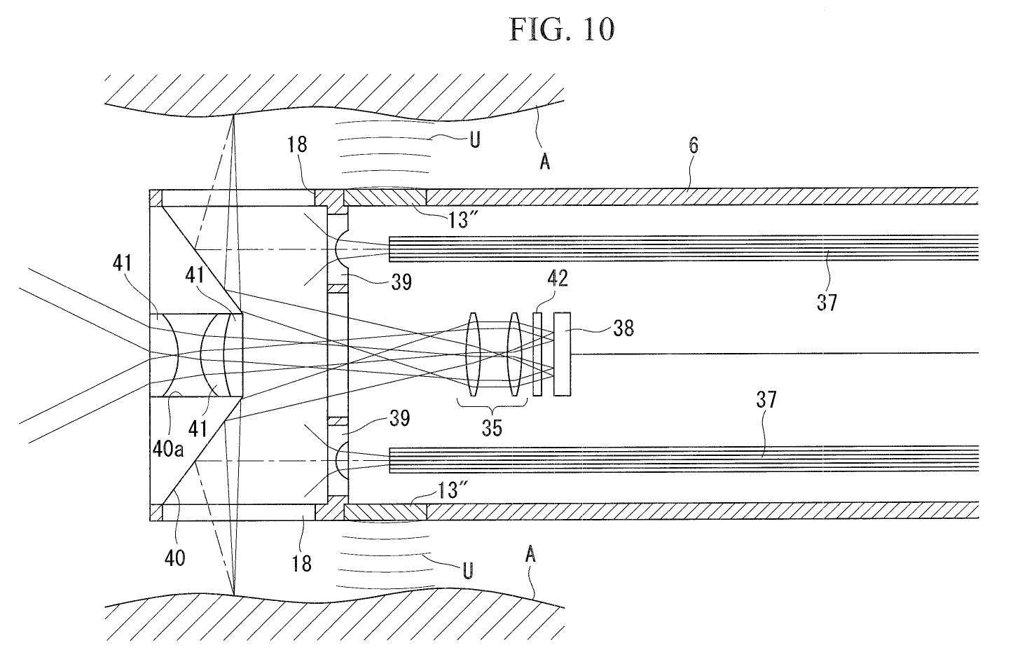

Furthermore, as shown in FIG. 10, a through-hole 40a may be provided at the center of the conical mirror 40, in which an observation optical system 41 is disposed, to obtain an image having a direct-view image (an image viewed from the tip of the probe main body 6) at the center of a fluorescence image around the whole circumference of the body-cavity inner wall A at one time.

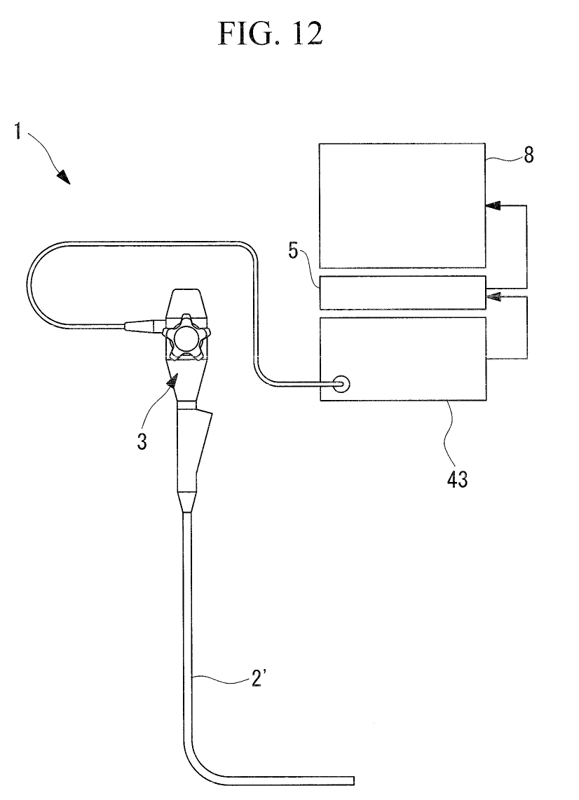

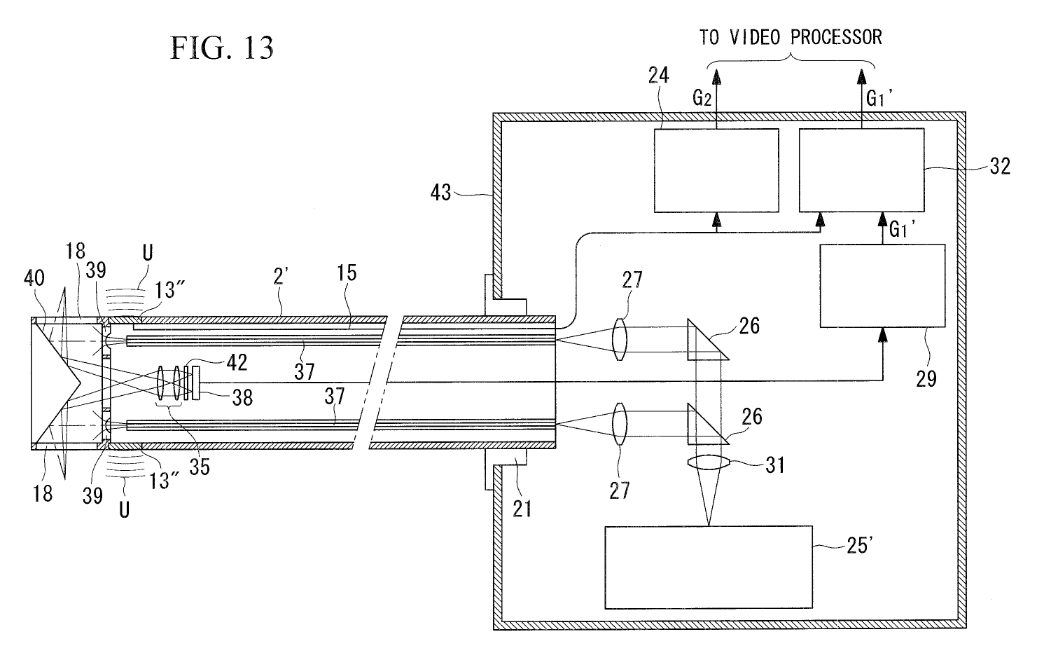

This embodiment has been described in terms of the case where the ultrasonic sensor array 13″ is provided on the probe main body 2 that is to be inserted into the body cavity through the forceps channel of the inserted portion 2 provided on the endoscope main body 3 of the endoscopic observation apparatus 1. However, as shown in FIG. 13, the ultrasonic sensor array 13″ may be disposed at the tip of an inserted portion (inserted member) 2′ (see FIG. 12). In this case, excitation light from a scope light source 25′ provided in a scope unit 43 connected to the trailing end of the inserted portion 2′ should be introduced to the tip of the inserted portion 2′ through the light-guide fibers 37, and the fluorescence returning from the body-cavity inner wall A should be focused by the image-capturing optical system 35 disposed at the tip of the inserted portion 2′ and should be captured by the two-dimensional CCD 38.

1. An endoscopic observation apparatus comprising, at the tip of an inserted member to be disposed in a body cavity:
a phototransmitter that radiates light onto a subject opposing the tip;
a photoreceptor that receives observation light returning from the subject;
an ultrasonic sensor that measures the absolute distance between the inserted member and the subject using oscillation of ultrasonic waves;
a correcting unit that corrects luminance information of the observation light on the basis of the absolute-distance information obtained by the ultrasonic sensor; and
an image generating unit that generates an image of the subject on the basis of the luminance information of the observation light corrected by the correcting unit.

2. The endoscopic observation apparatus according to claim 1, wherein
the phototransmitter is provided so as to be able to radiate light radially outward of the inserted member over a predetermined region in the circumferential direction;
the photoreceptor is provided so as to be able to receive observation light from the subject over the predetermined region in the circumferential direction; and
the ultrasonic sensor is disposed so as to be able to measure the absolute distances between individual positions in the predetermined region in the circumferential direction and the inserted member.

3. The endoscopic observation apparatus according to claim 2, further comprising a rotational driving unit that rotates at least one of the phototransmitter, the photoreceptor, or the ultrasonic sensor about the axis of the inserted member.

4. The endoscopic observation apparatus according to claim 3, wherein
the ultrasonic sensor is fixed with respect to the photoreceptor at a predetermined angle in the circumferential direction; and
the correcting unit corrects the luminance information of the observation light on the basis of absolute-distance information obtained with a shift in time necessary for rotation through the predetermined angle.

5. The endoscopic observation apparatus according to claim 1, further comprising a combined-image generating unit that combines the absolute-distance information obtained by the ultrasonic sensor and the luminance information of the observation light corrected by the correcting unit to generate a combined image in which the luminance information of the observation light is superposed on the outline shape of the subject.

6. An endoscopic observation method for imaging by radiating light from the tip of an inserted member disposed in a body cavity onto a subject disposed on the side thereof and receiving observation light returning from the subject, the method comprising:
a measuring step of measuring the absolute distance between the tip of the inserted member and the subject using oscillation of ultrasonic waves;
a correcting step of correcting luminance information of the observation light on the basis of the measured absolute distance; and
an image generating step of generating an image of the subject on the basis of the corrected luminance information of the observation light.
